(19) United States
(12) Patent Application Publication
(10) Pub. No.: US 2023/0103547 A1
(43) Pub. Date: Apr. 6, 2023

(54) COMMUNICATION DEVICE AND COMMUNICATION SYSTEM

(71) Applicant: FUJITSU LIMITED, Kawasaki-shi (JP)

(72) Inventor: Yoshiaki OHTA, Yokohama (JP)

(73) Assignee: FUJITSU LIMITED, Kawasaki-shi (JP)

(21) Appl. No.: 18/076,462

(22) Filed: Dec. 7, 2022

Related U.S. Application Data
(63) Continuation of application No. PCT/JP2020/024698, filed on Jun. 24, 2020.

(51) Int. Cl. H04W 76/15; H04L 27/26

(52) U.S. Cl. CPC H04W 76/15; H04L 27/26025; H04W 88/12

(57) ABSTRACT

A communication device includes, a communicator configured to include a first wireless communication layer and a second wireless communication layer, with the second wireless communication layer having a first link layer protocol or a second link layer protocol, which is a radio link protocol, and perform radio communication with another communication device via the first wireless communication layer, and a controller configured to control communication in transmission and reception of data of the second wireless communication layer by performing control on the data in accordance with whether a radio link protocol of the second wireless communication layer corresponds to the first link layer protocol or the second link layer protocol so that the transmission and reception of the data is performed.

### CROSS-REFERENCE TO RELATED APPLICATION

This application is a continuation application of International Application PCT/JP2020/024698 filed on Jun. 24, 2020 and designated the U.S., the entire contents of which are incorporated herein by reference.

### FIELD

The present disclosure relates to a communication device and a communication system.

### BACKGROUND

In current networks, the traffic of mobile terminals (smartphones and feature phones) occupies most of the network resources. In addition, the traffic used by mobile terminals is likely to continue to expand in the future.

Along with the development of the Internet of things (IoT) and V2X services (for example, traffic systems, smart meters, and monitoring systems for devices, etc.), services with various kinds of needs are expected to be handled. Accordingly, in the communication standard of the 5^{th} generation mobile communication (5G or NR (New Radio)), in addition to the standard technologies of 4G (4^{th} generation mobile communication) (for example, NPL 01: 3GPP TS36.133 V16.5.0 LTE-A Radio measurement specification; NPL 02: 3GPP TS36.300 V16.1.0 LTE-A General specification; NPL 03: 3GPP TS36.211 V16.1.0 LTE-A PHY channel specification; NPL 04: 3GPP TS36.212 V16.1.0 LTE-A PHY coding specification; NPL 05; 3GPP TS36.213 V16.1.0 LTE-A PHY procedure specification; NPL 06: 3GPP TS36.214 V16.0.0 LTE-A PHY measurement specification; NPL 07: 3GPP TS36.321 V16.0.0 LTE-A MAC specification; NPL 08: 3GPP TS36.322 V15.3.0 LTE-A RLC specification; NPL 09: 3GPP TS36.323 V16.0.0 LTE-A PDCP specification; NPL 10: 3GPP TS36.331 V16.0.0 LTE-A RRC specification; NPL 11: 3GPP TS36.413 V16.1.0 LTE-A S1 specification; NPL 12: 3GPP TS36.423 V16.1.0 LTE-A X2 specification; NPL 13: 3GPP TS36.425 V15.0.0 LTE-A Xn specification; NPL 14: 3GPP TR36.912 V15.0.0 NR Radio access outline; NPL 15: 3GPP TR38.913 V15.0.0 NR Requirements; NPL 16: 3GPP TR38.913 V15.0.0 NR Requirements; NPL 17: 3GPP TR38.801 V14.0.0 NR Network architecture outline; NPL 18: 3GPP TR38.802 V14.2.0 NR PHY outline; NPL 19: 3GPP TR38.803 V14.2.0 NR RF outline; NPL 20: 3GPP TR38.804 V14.0.0 NR L2 outline; NPL 21: 3GPP TR38.900 V15.0.0 NR Radio-frequency outline; NPL 22: 3GPP TS38.300 V16.1.0 NR General specification; NPL 23: 3GPP TS37.340 V16.1.0 NR Multi-connectivity general specification; NPL 24: 3GPP TS38.201 V16.0.0 NR PHY specification general specification; NPL 25: 3GPP TS38.202 V16.0.0 NR PHY service general specification; NPL 26: 3GPP TS38.211 V16.1.0 NR PHY channel specification; NPL 27: 3GPP TS38.212 V16.1.0 NR PHY coding specification; NPL 28: 3GPP TS38.213 V16.1.0 NR PHY data channel procedure specification; NPL 29: 3GPP TS38.214 V16.1.0 NR PHY control channel procedure specification; NPL 30: 3GPP TS38.215 V16.1.0 NR PHY measurement specification; NPL 31: 3GPP TS38.321 V16.0.0 NR MAC specification; NPL 32: 3GPP TS38.322 V16.0.0 NR RLC specification; NPL 33: 3GPP TS38.323 V16.0.0 NR PDCP specification; NPL 34: 3GPP TS37.324 V16.0.0 NR SDAP specification; NPL 35: 3GPP TS38.331 V16.0.0 NR RRC specification; NPL 36: 3GPP TS38.401 V16.1.0 NR Architecture general specification; NPL 37: 3GPP TS38.410 V16.1.0 NR Core network general specification; NPL 38: 3GPP TS38.413 V16.1.0 NR Core network AP specification; NPL 39: 3GPP TS38.420 V15.2.0 NR Xn interface general specification; NPL 40: 3GPP TS38.423 V16.1.0 NR XnAP specification; NPL 41: 3GPP TS38.470 V16.1.0 NR F1 interface general specification; and NPL 42: 3GPP TS38.473 V16.1.0 NR F1AP specification), there is a demand for a technology by which a higher data rate, a greater capacity, and lower delays are realized.

Further, in communication standards of wireless communication systems, specifications are typically defined as protocol stacks (also referred to as hierarchical protocols) in which wireless communication functions are divided into a series of layers.

Technologies relating to 5G are described in the abovementioned related art documents.

### Citation List

### Patent Literature

PTL1: Japanese Translation of PCT Application No. 2012-511863

PTL2: Japanese Patent Application Publication No. 2003-087856

### SUMMARY

However, the standardization of communication standards will not stop at 5G but will continue into the next generation (for example, beyond 5G (B5G) and 6G). The protocol configuration of the communication standard changes each time the generation (communication generation) changes. For example, the protocol configuration in the second layer (layer 2) and the first layer (layer 1) may change significantly. In the development of communication devices (terminal devices and base station devices), if the development is individually performed for each generation to correspond to this change in protocol configuration, the construction period will be lengthy, and the development costs will increase. In next-generation communication, communication devices of a plurality of generations is able to be connected in multiple ways to perform communication. When a plurality of communication devices or communication conditions in a communication area provided by the communication device vary, appropriately configuring a protocol or layer becomes difficult. As a result, the communication system as a whole may be unable to provide maximum communication characteristics.

According to one aspect of the present disclosure, a communication device includes, a communicator configured to include a first wireless communication layer and a second wireless communication layer, with the second wireless communication layer having a first link layer protocol or a second link layer protocol, which is a radio link protocol, and perform radio communication with another communication device via the first wireless communication layer, and a controller configured to control communication in transmission and reception of data of the second wireless communication layer by performing control on the data in accordance with whether a radio link protocol of the second wireless communication layer corresponds to the first link layer protocol or the second link layer protocol so that the transmission and reception of the data is performed.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 depicts a configuration example of a communication system 1.

FIG. 2 depicts a configuration example of a communication system 10.

FIG. 3 depicts a configuration example of the base station device 200.

FIG. 4 depicts a configuration example of the terminal device 100.

FIG. 5 depicts an example of TBS conversion processing S100, which is an example of the TBS control processing.

FIG. 6 depicts an example of a correspondence relationship between the B5G TBS and the 5G TBS.

FIG. 7 depicts an example of conversion between B5G TBS and 5G TBS.

FIG. 8 depicts an example of Num conversion processing S200.

FIG. 9 depicts an example of a correspondence relationship between the B5G Num and the 5G Num.

FIG. 10 depicts an example of a sequence of candidate notification processing.

FIG. 11 depicts an example of a candidate Num bitmap.

FIG. 12 depicts an example of a range of Nums.

FIG. 13 depicts an example of a sequence in a case where a selection result notification is not transmitted.

FIG. 14 depicts an example of a sequence of candidate notification processing.

FIG. 15 depicts an example of a correspondence relationship between the pattern number of the B5G Num and the 5G Num.

FIG. 16 depicts an example of a sequence of candidate notification processing.

FIG. 17 depicts an example of a sequence of candidate notification processing.

### DESCRIPTION OF EMBODIMENTS

Hereinafter, embodiments will be described in detail with reference to the drawings. The problems and examples in the present description are merely examples and do not limit the scope of rights of the present application. In particular, even if the described expressions are different, the technology of the present application is able to be applied to different expressions as long as they are technically equivalent, and the scope of rights is not limited.

### Embodiment 1

Embodiment 1 will be described.

FIG. 1 depicts a configuration example of a communication system 1. The communication system 1 includes a communication device 2.

The communication device 2 includes a controller and a communicator (not illustrated). Each entity is constructed by executing a program by a computer (processor) included in the communication device 2.

The communication device 2 includes a first wireless communication layer and a second wireless communication layer, typically, an n-th wireless communication layer. In addition, the second wireless communication layer supports (corresponds to) a first link layer protocol or a second link layer protocol, typically an m-th link layer protocol, which is a radio link protocol. An interface may be provided between the communicator (not illustrated) and the second wireless communication layer. An adaptation layer may also be provided as an intermediate layer.

The communication device 2 receives data D1 from another communication device (S1). The data D1 is data corresponding to the first link layer protocol or the second link layer protocol, typically the m-th link layer protocol.

The communication device 2 performs control processing, for example, adjustment, on the received data D1 in accordance with whether the data D1 corresponds to the first link layer protocol or the second link layer protocol, typically the m-th link layer protocol (S2).

For example, when the link layer protocol supported by the communication device 2 is different from the link layer protocol to which the data D1 corresponds, the communication device 2 performs mapping of parameters, conversion of a data size and format, adjustment of a data transmission rate, and the like so that the link layer protocol supported by the communication device 2 is able to process the data D1. For example, the communication device 2 converts parameters of the link layer protocol.

Next, the communication device 2 passes the adjusted data D1 to the second wireless communication layer (S3).

The communicator performs wireless communication with another communication device via the first wireless communication layer. For example, the communicator receives the data D1 described above.

In reception of data of the second wireless communication layer, the controller controls communication by performing adjustment on the data in accordance with whether the radio link protocol constituting the second wireless communication layer corresponds to the first link layer protocol or the second link layer protocol, typically the m-th protocol so as to receive the data. The controller performs, for example, the adjustment processing S2 and the delivery processing S3 described above.

In this way, for example, the construction period and development costs corresponding to the change of the protocol in accordance with the generation change are able to be reduced. This also makes it possible to appropriately control the protocol or layer configuration in accordance with, for example, a communication situation.

### Embodiment 2

Embodiment 2 will be described. Note that the following embodiments may be regarded as specific examples of Embodiment 1, for example. For example, the communication device of Embodiment 1 may correspond to a base station device 200 and a terminal device 100, the first wireless communication layer and the second wireless communication layer may correspond to either a 5G physical layer or a B5G physical layer, and the first link layer protocol and the second link layer protocol may correspond to either a 5G MAC layer or a B5G MAC layer.

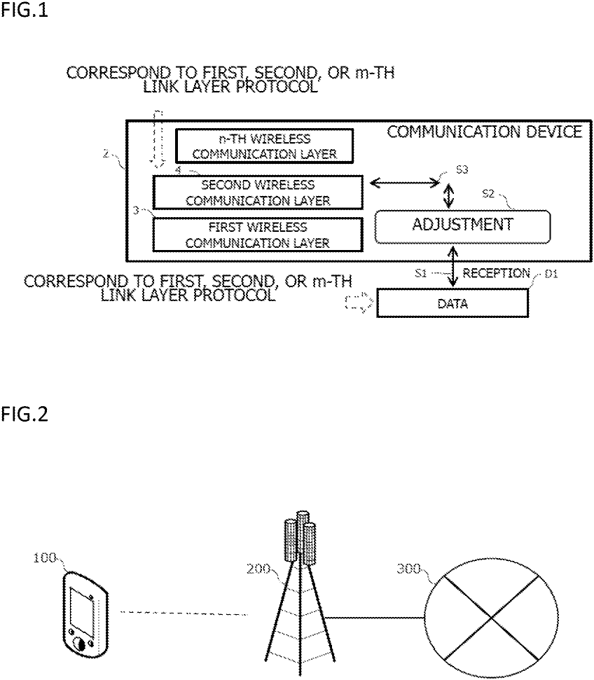

FIG. 2 depicts a configuration example of a communication system 10. The communication system 10 includes a terminal device 100, a base station device 200, and a core network 300. The communication system 10 is a system in which the terminal device 100 communicates with another communication device on the core network 300 via the base station device 200. The terminal device 100 and the base station device 200 may each be referred to as a communication device 50.

The terminal device 100 is wirelessly connected to the base station device 200 to perform communication. The terminal device 100 is, for example, a tablet terminal or a smartphone supporting both or one of 5G and B5G.

The base station device 200 is a relay device that relays communication between the terminal device 100 and another device. The base station device 200 is, for example, a communication device supporting both or one of 5G and B5G.

The core network 300 is, for example, a network that performs communication using Internet Protocol (IP) addresses. The core network is, for example, the Internet or a local network.

In the communication system 10, a medium access control (MAC) protocol data unit (PDU) that transmits and receives data is adjusted between the terminal device 100 and the base station device 200. For example, the base station device 200 notifies a format usable by the MAC PDU and selects the MAC PDU format to be used by the terminal device 100. This enables appropriate transmission and reception of MAC PDUs between the communication devices (the terminal device 100 and the base station device 200) supporting communication standards of different generations.

### Configuration Example of Base Station Device 200

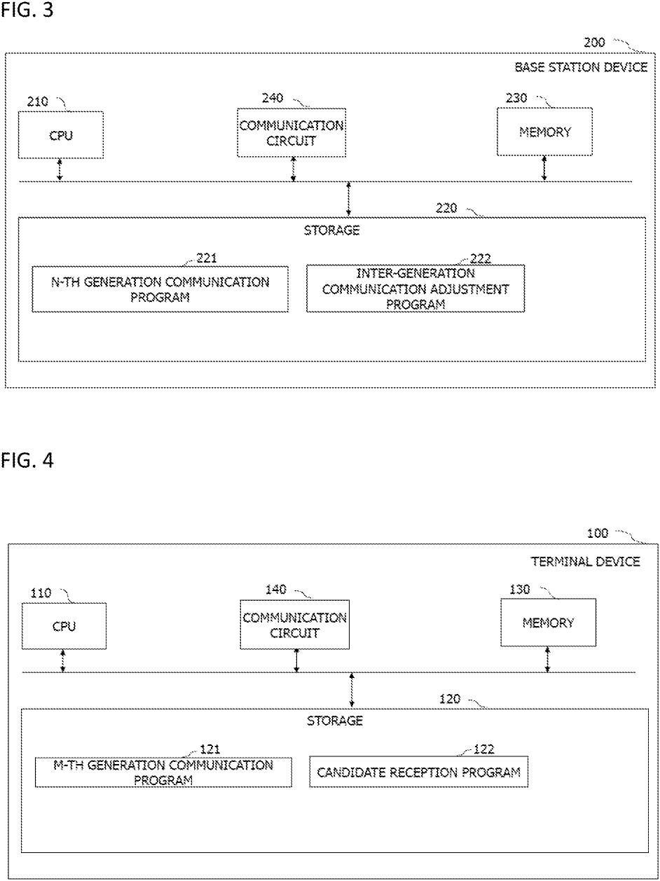

FIG. 3 depicts a configuration example of the base station device 200. The base station device 200 includes a central processing unit (CPU) 210, a storage 220, a memory 230, and a communication circuit 240.

The storage 220 is an auxiliary storage device, e.g., a flash memory, a hard disk drive (HDD), or a solid state drive (SSD) that stores programs and data. The storage 220 stores an N-th generation communication program 221 and an inter-generation communication adjustment program 222.

The memory 230 is an area into which a program stored in the storage 220 is loaded. The memory 230 may also be used as an area where the program stores data.

The communication circuit 240 is a circuit that connects to the terminal device 100 and the core network 300 to perform communication. The communication circuit 240 that communicates with the terminal device 100 and the communication circuit 240 that connects to the core network may be composed of a plurality of different communication circuits. For example, the communication circuit 240 that communicates with the terminal device 100 may be a device that supports wireless connection, and the communication circuit 240 that communicates with the core network 300 may be a device that supports wired connection.

The CPU 210 is a processor that loads a program stored in the storage 220 into the memory 230, executes the loaded program, constructs units, and performs processing.

By executing the N-th generation communication program 221, the CPU 210 constructs a communicator and a controller and performs N-th generation communication processing. The N-th generation communication processing is a process of executing communication conforming to the N-th generation communication standard. The N-th generation is, for example, 5G, B5G, 6G, and the like. The N-th generation may be another generation or another communication standard. The N-th generation communication processing is divided into layers, and processing corresponding to the N-th generation is performed in each layer.

By executing the inter-generation communication adjustment program 222, the CPU 210 constructs a controller and performs inter-generation communication adjustment processing. The inter-generation communication adjustment processing is a process of converting a MAC PDU received from the communication device 50 (terminal device 100) of a different generation such that the received MAC PDU conforms to the communication standard of the N-th generation supported by the own device.

### Configuration Example of Terminal Device 100

FIG. 4 depicts a configuration example of the terminal device 100. The terminal device 100 includes a CPU 110, a storage 120, a memory 130, and a communication circuit 140.

The storage 120 is an auxiliary storage device, e.g., a flash memory, an HDD, or an SSD that stores programs and data. The storage 120 stores an M-th generation communication program 121 and a candidate reception program 122.

The memory 130 is an area into which a program stored in the storage 120 is loaded. The memory 130 may also be used as an area where the program stores data.

The communication circuit 140 is a circuit that wirelessly connects to the base station device to perform communication. The communication circuit 140 is, for example, a network interface card.

The CPU 110 is a processor that loads a program stored in the storage 120 into the memory 130, executes the loaded program, constructs entities, and performs processing.

By executing the M-th generation communication program 121, the CPU 110 constructs a terminal communicator and a terminal controller and performs M-th generation communication processing. The M-th generation communication processing is a process of executing communication conforming to the M-th generation communication standard. The M-th generation is, for example, 5G, B5G, 6G, and the like. The M-th generation is a different generation from the N-th generation.

By executing the candidate reception program 122, the CPU 110 constructs a terminal communicator and a terminal controller and performs candidate reception processing. The candidate reception processing is a process of receiving candidates for parameters (for example, packet size, subcarrier spacing, and the like) relating to MAC PDUs to be transmitted, selecting a parameter to be used from the candidates, and using the selected parameter in subsequent MAC PDU transmissions.

### Processing for Adjusting MAC PDU Size

The MAC PDU size (data size) is defined in units of one byte as transport block size (TBS). The defined TBS is changed or added with the transition of generations of communication standards, and it is expected that changes and additions are to be made in future generations (for example, B5G). Therefore, the terminal device 100 and the base station device 200, or one of these devices (communication device 50) adopts TBS as a parameter for control processing and performs control processing relating to TBS, for example, TBS conversion processing. The TBS conversion processing is an example of the inter-generation communication adjustment processing.

FIG. 5 depicts an example of TBS conversion processing S100, which is an example of the TBS control processing. FIG. 5 is a diagram illustrating a case in which the communication device 50 supporting 5G (having a MAC layer supporting 5G) receives a MAC PDU in TBS defined by B5G.

The specifications of the communication device 50 supporting 5G are defined, for example, as a protocol stack (also referred to as a layered protocol) in which wireless communication functions are divided into a series of layers. In FIG. 5, the communication device 50 includes a 5G physical layer, a MAC layer, a radio link control (RLC) layer, a packet data convergence protocol (PDCP) layer, and a service data adaptation protocol (SDAP) layer, which correspond to 5G. The TBS conversion processing S100 may be a function of the 5G physical layer or may be a function of the MAC layer. In addition, the TBS conversion processing S100 may have an interface between the 5G physical layer and the MAC layer. Further, as an intermediate layer between the 5G physical layer and the MAC layer, an adaptation layer that performs conversion processing of the both layers may be provided.

The communication device 50 receives a MAC PDU corresponding to the TBS of B5G from another communication device that has a B5G physical layer supporting B5G (S10). When receiving the MAC PDU corresponding to the B5G TBS (S10), the communication device 50 performs the TBS conversion processing S100 to convert the received MAC PDU into a MAC PDU corresponding to the TBS of 5G and passes the converted MAC PDU to the MAC layer (S11).

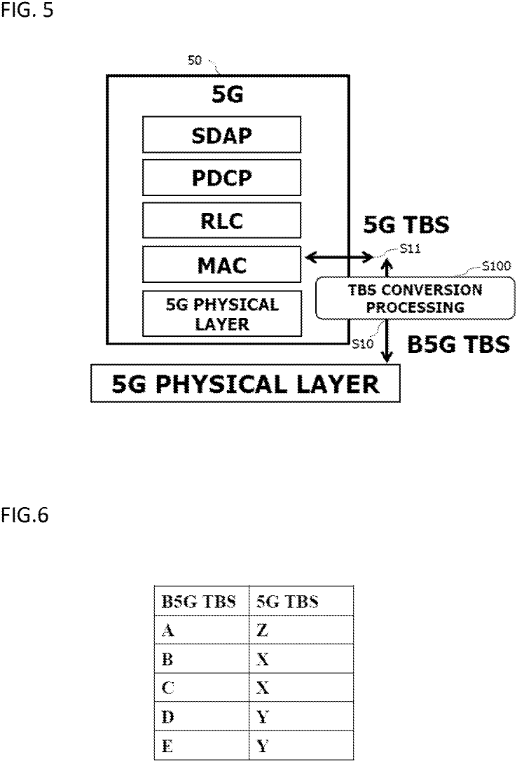

FIG. 6 depicts an example of a correspondence relationship between the B5G TBS and the 5G TBS. A, B, C, D, and E represent indexes of the B5G TBSs, and X, Y, and Z represent indexes of the 5G TBSs. Instead of the index, a size (the number of bytes) may be used. Note that since it is expected that there will be more TBSs to be handled as the generation progresses, there may be an overlapping 5G TBS (for example, X corresponds to two B5G TBSs, which are B and C, and Y corresponds to two B5G TBSs, which are D and E) as illustrated in FIG. 6.

In the TBS conversion processing S100, for example, when the communication device 50 receives a MAC PDU with the index A (corresponding to B5G), the communication device 50 converts the MAC PDU into a MAC PDU with the index Z (corresponding to 5G) in accordance with the correspondence relationship in FIG. 6 and passes the converted MAC PDU to the MAC layer.

In Embodiment 2, having the TBS conversion processing S100 makes it possible to receive and transmit a MAC PDU in B5G without making a change (development) to the MAC layer and the upper layers to correspond to B5G.

The communication device 50 may store the correspondence relationship illustrated in FIG. 6 in advance. The communication device 50 may perform different control processing. For example, the communication device 50 may select a TBS that is less than the B5G TBS and is the greatest of the 5G TBSs. In this way, the 5G TBS that is close to the B5G TBS is able to be selected. The communication device 50 may also select a TBS that is greater than the B5G TBS and is the least of the 5G TBSs.

In addition, for instance, the B5G TBS may be greater than the maximum TBS supported by 5G. In this case, in the TBS conversion processing S100, the communication device 50 on the transmission side may aggregate a plurality of 5G TBSs to form one great TBS, and the communication device 50 on the reception side may reassemble the aggregate TBS and extract individual TBSs.

Specific examples will be described below. In a case of downlink communication, the communication device 50 on the transmission side aggregate TBSs as described above and transmits the aggregate TBS to the communication device 50 on the reception side. When receiving the aggregate TBS, the communication device 50 on the reception side performs reassembly and extracts the original TBSs.

In a case of uplink communication, the communication device 50 on the transmission side aggregates a plurality of TBSs so as to obtain the TBS specified by a dynamic grant or a configured grant from the communication device 50 on the reception side. Next, the communication device 50 on the transmission side transmits the aggregate TBS to the communication device 50 on the reception side. When receiving the aggregate TBS, the communication device 50 on the reception side performs reassembly and extracts the original TBSs.

When aggregating a plurality of TBSs in the TBS conversion processing S100, the communication device 50 adjusts the number of TBSs to be aggregated. For instance, the communication device 50 notifies the MAC layer of the number of TBSs to be aggregated. In the case of downlink communication, this number corresponds to the number of times that downlink radio resource assignment (for instance, DL assignment) is performed. In the case of uplink communication, this number corresponds to the number of times that uplink radio resource assignment (for instance, UL grant) is performed. This is because the MAC layer generates a TB in response to a TB generation request from the PHY layer.

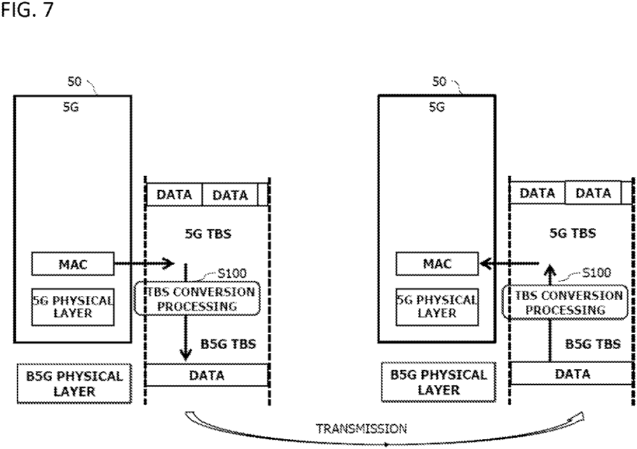

The information on the number of TBSs aggregated by the communication device 50 on the transmission side needs to be shared with the communication device 50 on the reception side. As a sharing method, a predefined method as illustrated in FIG. 7 is able to be used. For instance, when the maximum TBS of 5G is X and the TBS of data transmitted by B5G is 2 × X + n (n<X), two of the TB whose TBS is the maximum TBS are aggregated, and one TBS whose TBS is n is further aggregated so as to construct one TBS to be transmission data. In this way, the number of TBSs to be aggregated is able to be minimized so that the header overhead associated with TBSs is able to be reduced. As illustrated in FIG. 7, as the TBS of 5G, two pieces of TBS data and one piece of less TBS data are aggregated to form one B5G TBS data.

The method for configuring one great TBS is not limited to the above method. For instance, there is a method in which the maximum TBS of 5G is extended to support the B5G TBS. In this case, the TBS of data transmitted by B5G is the same as the TBS constructed in the MAC layer. Therefore, the control processing S100 does not need to adjust the size of TBS but only needs to transmit the TB from the MAC layer to B5G. Thus, the processing amount is reduced.

According to the present embodiment, it is possible to perform communication using B5G while utilizing the MAC layer of 5G. As a result, an increase in construction period and development costs to correspond to the generation change are able to be reduced. In addition, communication characteristics is able to be improved, compared to a case where communication is performed using a link layer protocol including a MAC layer developed specifically for B5G. For instance, in a case where the B5G traffic load is heavy, if a B5G-specific link layer protocol is used, resources, e.g., the CPU and the memory are used even though the full performance of the link layer protocol is unlikely to be delivered. However, by utilizing the link layer protocol of 5G, B5G resources is able to be conserved and assigned to needed traffic so that the traffic is able to be provided with QoS. There are also cases where 4G communication is performed using the link layer protocol of 5G, which is, for instance, when traffic is offloaded. The use of the 5G-specific link layer protocol for serving traffic would be over-performance. Therefore, by offloading to 4G, 5G resources are able to be conserved, and the 5G coverage and capacity are able to be maintained.

### Embodiment 3

Embodiment 3 will be described. According to Embodiment 3, a communication device 50 includes Num conversion processing for adjusting MAC PDU numerology (Num: subcarrier spacing, for instance). In the present embodiment, compared with Embodiment 2, the control processing differs from the TBS conversion processing denoted by S100. However, the other functions and processing are the same as those of Embodiment 2. Therefore, unless otherwise specified, the contents disclosed in Embodiment 2 are also able to be applied to the present embodiment.

### Num Conversion Processing

As the control processing, control processing relating to Num conversion, for instance, Num conversion processing is performed. The Num control processing has a control time scale greater than that of the TBS control processing. This is because the TBS control processing involves packet scheduling. For instance, the packet scheduling includes a dynamic grant in which data transmission is controlled by a PDCCH and a configured grant in which data transmission is controlled by resource assignment in advance, instead of the PDCCH. In any case, since data transmission operates at high speed on a time scale of ms, it is desirable that the TBS control processing be performed with speed. However, a case where a Num is changed during communication does not frequently occur, and it is able to be said that the same Num is continuously used during communication. Therefore, while the TBS control processing is preferably performed in accordance with a predetermined rule, a rule is able to be changed during communication in the Num control processing since the Num control processing is not performed at high speed.

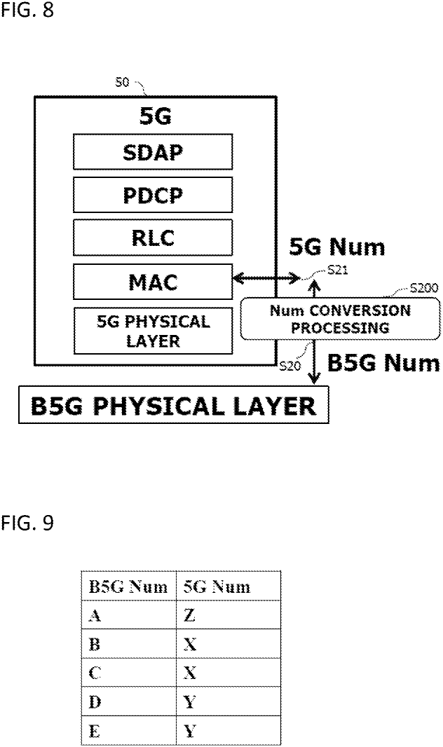

FIG. 8 depicts an example of Num conversion processing S200. FIG. 8 is a diagram illustrating a case in which the communication device 50 supporting 5G (having a MAC layer supporting 5G) receives a MAC PDU of Num defined by B5G. The Num conversion processing is an example of the inter-generation adjustment processing.

The Num conversion processing S200 may be a function of the 5G physical layer or a function of the MAC layer. In addition, the Num conversion processing S200 may have an interface between the 5G physical layer and the MAC layer.

The communication device 50 receives a MAC PDU corresponding to Num of B5G from another communication device that has a B5G physical layer supporting B5G (S20). When receiving the MAC PDU corresponding to the B5G Num (S20), the communication device 50 performs Num conversion processing S200 to convert the received MAC PDU into a MAC PDU corresponding to Num of 5G and passes the converted MAC PDU to the MAC layer (S21).

FIG. 9 depicts an example of a correspondence relationship between the B5G Num and the 5G Num. A, B, C, D, and E represent indexes of the B5G Nums, and X, Y, and Z represent indexes of the 5G Nums. Instead of the index, a time length per slot may be used.

In the Num conversion processing S200, when the communication device 50 receives, for instance, a MAC PDU with the index A, the communication device 50 converts the MAC PDU into a MAC PDU with the index Z in accordance with the correspondence relationship in FIG. 9 and passes the converted MAC PDU to the MAC layer.

In Embodiment 3, by having the Num conversion processing S200, the communication device 50 is able to receive and transmit a B5G MAC PDU without making a change (development) to the MAC layer and the upper layers to correspond to B5G.

According to the present embodiment, the same advantageous effects as those of Embodiments 1 and 2 are able to be obtained. For instance, according to the present embodiment, it is possible to reduce the number of man-hours for development (development to correspond to the protocol) for absorbing the difference in Numerology of corresponding PDUs in communication protocols of different generations.

### Embodiment 4

Embodiment 4 will be described. In the present embodiment, a communication device 50 performs control processing for facilitating selection of a Num in Embodiment 3, and the other functions and processing are the same as those of Embodiment 3. Thus, unless otherwise specified, the contents disclosed in Embodiment 3 are able to be applied to the present embodiment.

In order to perform the Num conversion processing S200, a Num having an approximate time length is selected, and information on a Num that is able to be handled by a peer communication device is obtained. In addition, the communication device 50 uses a Num selected from a certain number of candidates so that the Num is able to be selected in accordance with, for instance, radio conditions, an amount of data to be transmitted, a processing load, or the like.

Therefore, in Embodiment 4, the communication device 50 notifies information on a Num to support and a Num to be selected and used. Hereinafter, processing for notifying transmission candidates will be described using the terminal device 100 and the base station device 200 as examples. Note that the terminal device 100 and the base station device 200 may each be a different communication device 50. Depending on the device configuration, a message for notifying the Num to support may be used instead of the UE capability.

### Candidate Notification Processing

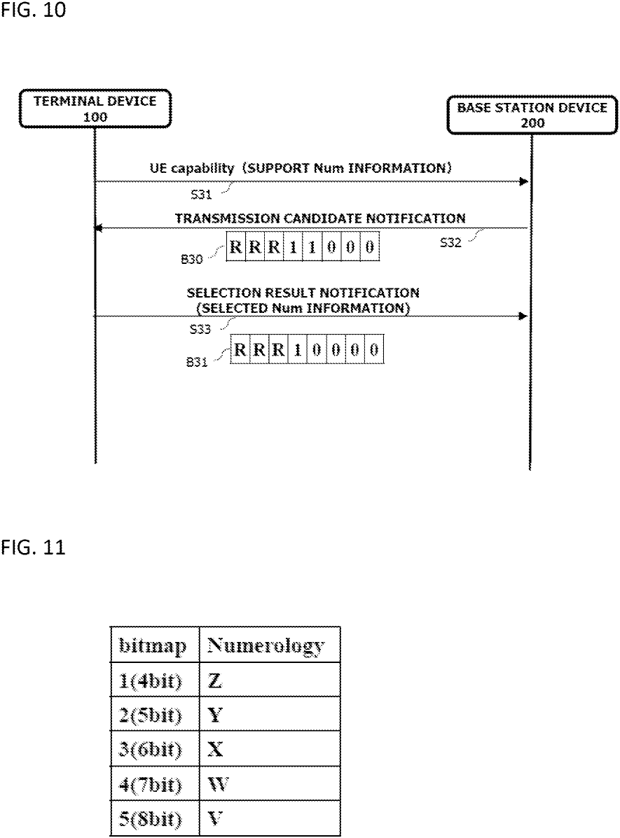

FIG. 10 depicts an example of a sequence of candidate notification processing. The terminal device 100 transmits UE capability including support Num information on a Num (support parameter) supported by the terminal device 100 to the base station device 200 (S31). The terminal device 100 may use UE Assistance Information instead of the UE capability.

The terminal device 100 returns the UE capability to the base station in response to a request from the network or the base station device 200. The functions to be installed in the terminal device 100 for wireless communication are commonly selected from a number of functions and determined by a manufacturer. By notifying the network or the base station device 200 of the implemented (supported) functions, the network or the base station device 200 is able to set only the implemented functions.

On the other hand, the terminal device 100 voluntarily transmits the UE Assistance Information to the base station device 200. The terminal device 100 notifies the network or the base station device 200 of communication-related information, e.g., a preferrable communication parameter. In other words, the terminal device 100 provides auxiliary information to allow the base station device 200 to perform preferable settings when the base station device 200 sets communication-related information, e.g., a parameter for the terminal device 100.

The base station device 200 compares the B5G Num that the base station device 200 is able to support with the 5G Num that the terminal device 100 is able to support, based on the support Num information. The base station device 200 extracts a 5G Num that resembles, in subcarrier length, the B5G Num supported by the base station device 200 and that is supported by the terminal device 100, and the extracted 5G Num is set as a candidate Num (candidate parameter).

The base station device 200 transmits a transmission candidate notification including the candidate Num information regarding the candidate Num to the terminal device 100 (S32). The candidate Num is notified by using a bitmap, for instance.

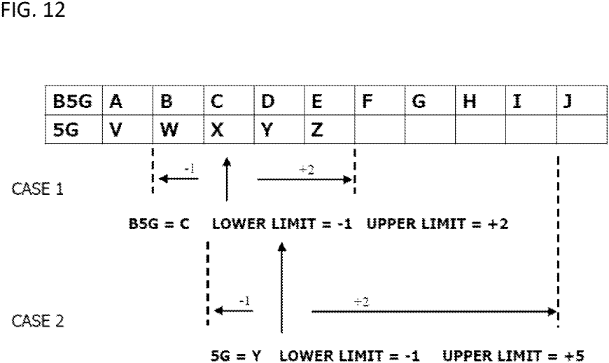

A bitmap B30 is information on a certain 8-bit (1-byte) candidate Num, and each cell indicates 1 bit. “R” in each of the front three bits indicates, for instance, a reserved bit, which is used for other purposes or not used. Each of the last 5 bits corresponds to the bitmap illustrated in FIG. 11, where “1” indicates a usable (candidate) Num, and “0” indicates an unusable (non-candidate) Num.

FIG. 11 depicts an example of a candidate Num bitmap. For instance, the first bit (the fourth bit in 1 byte) corresponds to “Z” which is one of the 5G Nums.

Returning to the sequence of FIG. 10, the bitmap B30 indicates that 5G Nums “Z” and “Y” are candidate Nums since the fourth and fifth bits each indicate “1”.

When the terminal device 100 receives the transmission candidate notification (S32), the terminal device 100 selects a Num to be used from the candidate Nums and transmits a selection result notification including selected Num information regarding the selected Num to the base station device 200 (S33).

A bitmap B31 is the selected Num information and has a configuration resembling the candidate Num information. Each of the last 5 bits corresponds to the bitmap illustrated in FIG. 11, where “1” indicates the selected Num, and “0” indicates the unselected Num. The bitmap B31 indicates that the 5G Num “Z” is the selected Num since the fourth bit is “1”.

The base station device 200 acquires that the 5G Num “Z” has been selected, and thereafter, in the Num conversion processing S200, the base station device 200 selects a B5G Num that approximates (corresponds to) “Z” and performs conversion processing.

### Example of Method for Expressing Num Range

In a case where the UE capability is not transmitted, for instance, the communication device 50 notifies (or may previously determine) a range of approximation (a range of allowable Nums) between 5G and B5G.

FIG. 12 depicts an example of a range of Nums. The table is a basic mapping, and 5G Nums and B5G Nums have a one-to-one correspondence. It is assumed that the communication device 50 has the basic mapping in advance. The communication device 50 notifies another communication device of the allowable width (upper limit, lower limit) in addition to a Num as a reference. In this way, when the correspondence between B5G and 5G is changed, the peer communication device is able to acquire Nums included in the approximate range (the range allowable by the peer device) and select an appropriate Num.

Case 1 is an example case in which, for instance, B5G radio communication planned to be performed is changed to be performed as 5G radio communication due to traffic offload or the like. In Case 1, a B5G Num “C” is a reference Num, and the allowable upper limit and lower limit are “+2” and “-1” respectively.

In addition to a 5G Num “X” corresponding to the B5G Num “C”, the communication device 50 also allows “Y” and “Z” obtained by shifting upward to the upper limit and “W” obtained by shifting downward to the lower limit. That is, the communication device 50 allows “W” to “Z” as 5G Nums.

Case 2 is an example case in which, for instance, 5G radio communication planned to be performed is changed to be performed as B5G radio communication due to a factor, e.g., improvement in characteristics. In Case 2, a 5G Num “Y” is a reference Num, and the allowable upper limit and lower limit are “+5” and “-1”, respectively.

In addition to a B5G Num “D” corresponding to the 5G Num “Y”, the communication device 50 also allows “E” to “I” obtained by shifting upward to the upper limit and “C” obtained by shifting downward to the lower limit. That is, the communication device 50 allows “C” to “I” as B5G Nums.

### Example of Not Transmitting Selection Result Notification

The communication device 50 (terminal device 100) does not transmit a selection result notification. Therefore, the peer communication device 50 (base station device 200) performs blind decoding when receiving a MAC PDU.

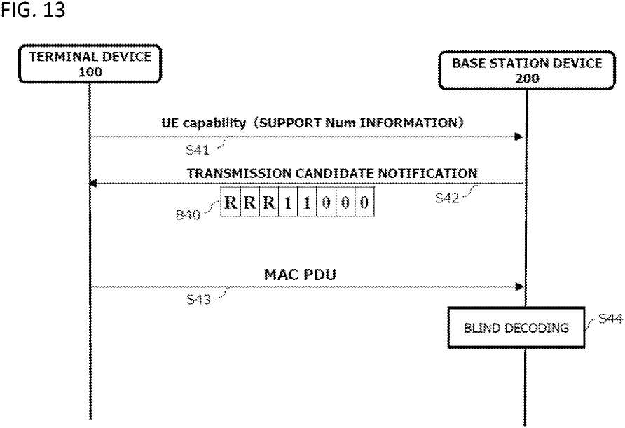

FIG. 13 depicts an example of a sequence in a case where a selection result notification is not transmitted. Processing S41, processing S42, and a bitmap B40 resemble the processing S31, the processing S32, and the bitmap B30, respectively.

When receiving a transmission candidate notification (S42), the terminal device 100 selects a Num from the candidate Nums. Alternatively, the terminal device 100 may store the candidate Nums and select a Num to be used from the candidate Nums when transmitting a MAC PDU.

At the time of transmitting the MAC PDU, the terminal device 100 uses the selected Num to transmit the MAC PDU (S43).

Since the base station device 200 has not received the selection result notification, the base station device 200 performs blind decoding (S44). The blind decoding S44 is a process of decoding all the candidate Nums and determining the Num that has been successfully decoded as the Num of the MAC PDU.

The base station device 200 may store the Num successfully decoded in the blind decoding, and thereafter, may use the stored Num to perform decoding when receiving a MAC PDU from the terminal device 100. The base station device 200 may also perform blind decoding S44 every time the base station device 200 receives a MAC PDU from the terminal device 100.

### Example of Bitmap Pattern of Transmission Candidate Notification

Another example of the bitmap pattern of the transmission candidate notification will be described below.

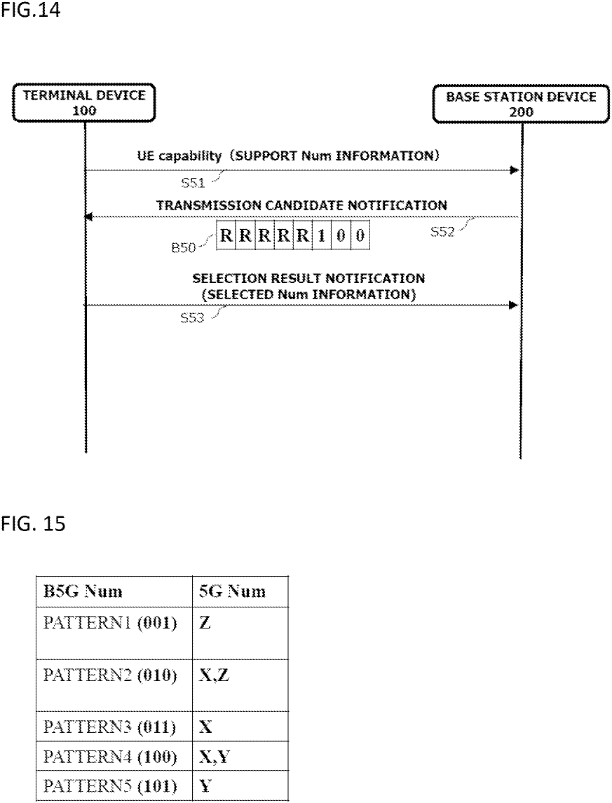

FIG. 14 depicts an example of a sequence of candidate notification processing. The terminal device 100 transmits UE capability including support Num information regarding the Num supported by the terminal device 100 to the base station device 200 (S51).

Based on the support Num information, the base station device 200 compares the B5G Num that the own device is able to support with the 5G Num that the terminal device 100 is able to support. The base station device 200 extracts the 5G Num that the terminal device 100 is able to support and that approximates in subcarrier length to the B5G Num supported by the base station device 200 and sets the extracted 5G Num as a candidate Num. The base station device 200 selects the pattern number of the B5G Num that matches (or approximates to) the selected candidate Num.

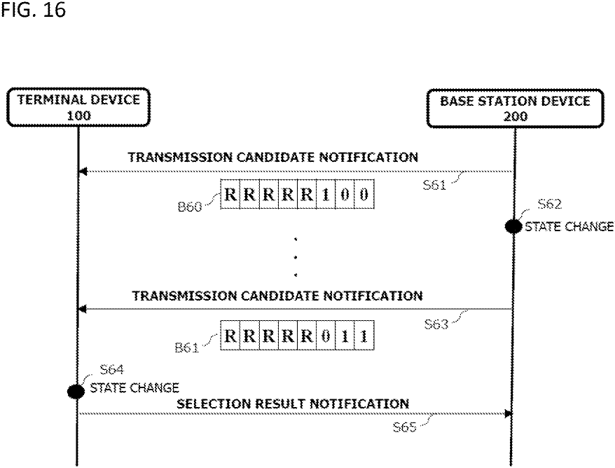

FIG. 15 depicts an example of a correspondence relationship between the pattern number of the B5G Num and the 5G Num. The terminal device 100 and the base station device 200 store the correspondence relationship in advance or by receiving the correspondence relationship. Numerical values in parentheses in FIG. 15 indicate examples of a 3-bit bit pattern. The base station device 200 transmits the candidate Num to the terminal device 100 using the corresponding 3-bit bit pattern.

Returning to the sequence in FIG. 14, the base station device 200 selects, for instance, pattern 4 of the B5G Num. Next, the base station device 200 includes the bitmap B50 including the bit pattern “100” of the pattern 4 in a transmission candidate notification and transmits the transmission candidate notification to the terminal device 100 (S52).

When receiving the transmission candidate notification (S52), the terminal device 100 acquires that the pattern number of the B5G Num is the pattern 4 and acquires that the candidate Nums are “X” and “Y” from the correspondence relationship illustrated in FIG. 14.

The terminal device 100 selects a Num to be used from the candidate Nums, includes selected Num information on the selected Num in a selection result notification, and transmits the selection result information to the base station device 200 (S53).

The selected Num information may be, for instance, a bitmap in which a bit corresponding to the selected Num is set to “1” as in the sequence in FIG. 10. In addition, no selection result notification may be transmitted when there is only one candidate Num, e.g., the pattern 1, 3, or 5 in FIG. 15, for instance.

By providing a B5G Num pattern, the communication device 50 may be able to perform transmission with a lower number of bits than the bitmap in which one bit is used for one type of 5G Num.

### Example of Case Where State Change Occurs

When a change occurs in a state (for instance, a radio state, a communication amount, or the like) of the communication device 50 (base station device 200), a transmission candidate notification is transmitted.

FIG. 16 depicts an example of a sequence of candidate notification processing. The base station device 200 transmits a transmission candidate notification to the terminal device 100 (S61). The correspondence relationship in FIG. 15 is used for the bitmap of the candidate Num. In FIG. 16, a bitmap B60 (pattern 4) is transmitted.

A state change then occurs in the base station device 200 (S62). The state change indicates a case where a QoS level, a traffic amount in a cell, a radio wave state (noise state or the like), or the like becomes equal to or more than or less than a threshold. The state change may also be a state relating to the terminal device 100, for instance, a battery state of the terminal device 100.

When the base station device 200 detects the state change (S62), the base station device 200 selects a Num candidate corresponding to the changed state and transmits a transmission candidate notification again (S63). In FIG. 16, a bitmap B61 (pattern 3) is transmitted.

The transmission candidate notification is transmitted by, for instance, a radio resource control (RRC) message. In addition, the transmission candidate notification is transmitted by a MAC control element (CE) message. Further, the transmission candidate notification is transmitted by a physical downlink control channel (PDCCH).

Same as the base station device 200, when the terminal device 100 detects a state change (S64), the terminal device 100 changes the Num to be used in accordance with the changed state and transmits a selection result notification including information on the changed Num (S65).

The terminal device 100 and the base station device 200 change the Num (candidate Num, selected Num) in accordance with the state change and notifies the peer communication device of the change. In this way, the Num is able to be dynamically changed in accordance with the changing state.

### Example of Transmission Candidate Notification

The communication device 50 notifies the B5G pattern number illustrated in FIG. 15 and an index number included in the pattern number by using the transmission candidate notification. The index number is a number assigned to an individual 5G Num when there is a plurality of 5G Nums in each pattern. For instance, in FIG. 15, the pattern 4 has two 5G Nums, which are “X” and “Y”, and index 1 and index 2 are assigned to “X” and “Y”, respectively.

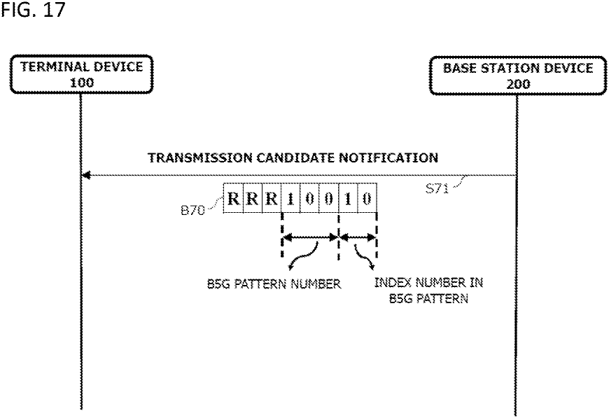

FIG. 17 depicts an example of a sequence of candidate notification processing. The base station device 200 transmits the transmission candidate notification to the terminal device 100 (S71). In FIG. 17, a bitmap B70 is transmitted.

The bitmap B70 represents the candidate Num using the lower five bits (the fourth to eighth bits). Three bits from the fourth bit to the sixth bit indicate the B5G pattern number. Two bits of the seventh and eighth bits indicate the index number. The seventh bit corresponds to the index 1, and the eighth bit corresponds to the index 2. When the seventh and eighth bit are “1”, the 5G Num of the corresponding index number is a candidate Num.

The fourth to sixth bits of the bitmap B70 are “100”, which indicates the pattern 4 of the B5G Num. Further, in the bitmap B70, the seventh bit is “1”, and the eighth bit is “0” which indicates that the 5G Num “X” is a candidate Num, but the 5G Num “Y” is not a candidate Num.

In this way, depending on the formation of the patterns illustrated in FIG. 15 and the number of 5G candidate Nums, by notifying a combination of the pattern and the index number, the candidate Num is able to be notified with a lower number of bits.

According to the present embodiment, advantageous effects resembling those of Embodiments 1, 2, and 3 are able to be obtained. According to the present embodiment, for instance, the number of bits of the transmission candidate information is able to be reduced. A more efficient bit pattern (with a lower number of bits) or transmission method is able to be selected for the transmission candidate notification in accordance with the type of Num supported by each protocol or the number of Nums that is able to be supported by each device. In addition, according to the present embodiment, by omitting the selection result notification, the number of transmissions of messages is able to be reduced, and the radio resources are able to be effectively utilized.

### Other Embodiments

The above embodiments may be combined. For instance, the bitmap pattern of the transmission candidate notification, the presence or absence of the selection result notification, the transmission timing of the transmission candidate notification, and the like in the respective embodiments may be combined.

In addition, as long as the terminal device 100 and the base station device 200 support different generations of communication standards, it does not matter which generation of communication standard each device supports.

According to one aspect of the present disclosure, an increase in construction period and development costs to correspond to the generation change are able to be reduced. Further, according to one aspect of the present disclosure, it is possible to appropriately control a protocol or a layer configuration in accordance with communication conditions.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A communication device comprising:
a communicator configured to include a first wireless communication layer and a second wireless communication layer, with the second wireless communication layer having a first link layer protocol or a second link layer protocol, which is a radio link protocol, and perform radio communication with another communication device via the first wireless communication layer; and
a controller configured to control communication in transmission and reception of data of the second wireless communication layer by performing control on the data in accordance with whether a radio link protocol of the second wireless communication layer corresponds to the first link layer protocol or the second link layer protocol so that the transmission and reception of the data is performed.

2. The communication device according to claim 1, wherein when the second wireless communication layer does not support the first link layer protocol, in transmission and reception of data corresponding to the first link layer protocol from and to the other communication device, the controller adjusts a first parameter, which is a parameter of the first link layer protocol of the data, to a second parameter, which is a parameter of the second link layer protocol, in the control so that the data corresponds to the second link layer protocol, and passes the data to the second wireless communication layer.

3. The communication device according to claim 2, wherein
the parameter is information regarding a size of a packet that transmits the data, and
the controller configured to set, as a second parameter, a parameter indicating a size that is equal to or less than a data size of the first parameter and is the greatest with which the communication device is capable of handling.

4. The communication device according to claim 2, wherein
the parameter is information regarding a size of a packet that transmits the data, and
the controller configured to set, as a second parameter, a parameter indicating a size that is equal to or greater than a data size of the first parameter and is the smallest with which the communication device is capable of handling.

5. The communication device according to claim 2, wherein the parameter is information regarding subcarrier spacing of a packet that transmits the data.

6. The communication device according to claim 5, wherein the controller configured to set, as a second parameter, a parameter that is equal to the subcarrier spacing of the first parameter or that has a small difference from the subcarrier spacing of the first parameter.

7. The communication device according to claim 5, wherein the controller configured to receive a support parameter, which is a parameter of the first link layer protocol supported by the other communication device, select, from the support parameter, a parameter that is equal to or approximates to a parameter of the second link layer protocol supported by the communication device, and notify the other communication device of the parameter as a candidate parameter.

8. The communication device according to claim 7, wherein the support parameter is included in user equipment (UE) capability.

9. The communication device according to claim 7, wherein the support parameter is included in user equipment (UE) assistance information.

10. The communication device according to claim 7, wherein the notification is performed by radio resource control (RRC).

11. The communication device according to claim 7, wherein the notification is performed by medium access control (MAC), a control element (CE), or a physical data control channel (PDCCH).

12. The communication device according to claim 7, wherein the controller configured to perform the notification when the communication device detects that a state of the communication device or the other communication device has changed.

13. A communication device comprising:
a communicator configured to include a first wireless communication layer and a second wireless communication layer, with the second wireless communication layer having a first link layer protocol or a second link layer protocol, which is a radio link protocol, and perform radio communication with another communication device via the first wireless communication layer; and
a controller configured to control communication in transmission and reception of data of the second wireless communication layer by performing control on the data in accordance with a parameter of the first link layer protocol or the second link layer protocol that is received from the other communication device so that the transmission and reception of the data is performed.

14. A communication system comprising:
a first communication device and a second communication device, wherein
the first communication device configured to include a first wireless communication layer and a second wireless communication layer, with second wireless communication layer having a first link layer protocol, which is a radio link protocol,
the second communication device configured to include the first wireless communication layer and the second wireless communication layer, with second wireless communication layer including a second link layer protocol, which is a radio link protocol,
the second communication device configured to transmit, to the first communication device, data corresponding to the second link layer protocol, and
the first communication device configured to perform radio communication with the second communication device via the first wireless communication layer, and in reception of data of the second wireless communication layer, when the first communication device receives, from the second communication device, data corresponding to the second link layer protocol, the first communication device performs control on the data so that the data corresponds to the first link layer protocol.
